(19) United States
(12) Patent Application Publication
(10) Pub. No.: US 2005/0110392 A1
(43) Pub. Date: May 26, 2005

(54) Field emission display device

(75) Inventor: Seong-Hak Moon, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 10/984,878

(22) Filed: Nov. 10, 2004

(30) Foreign Application Priority Data
Nov. 26, 2003 (KR) 84651/2003

(51) Int. Cl. H01J 1/62; H01J 63/04

(52) U.S. Cl. 313/495

(57) ABSTRACT

The present invention discloses a field emission device which can improve luminance and uniformity of screen by enabling electrons emitted from a plurality of carbon nano tubes to evenly excite the whole surface of a fluorescent substance. The field emission device includes a bottom gate electrode formed on a bottom substrate, an insulation layer being formed on the bottom gate electrode, and having a via hole partially exposing the bottom gate electrode, a first top gate electrode formed on the insulation layer, and coupled to the bottom gate electrode exposed through the via hole, a first cathode electrode formed on the insulation layer on the same plane surface as that of the first top gate electrode, and a first carbon nano tube formed on the left side of the first cathode electrode, and a second carbon nano tube formed on the right side of the first cathode electrode.

### BACKGROUND OF THE INVENTION

1. Field of the Invention

The present invention relates to a field emission display, and more particularly to, a field emission display device.

2. Description of the Background Art

According to rapid development of the information and communication technologies and visualization of various information, demands for a display have increased and the structure of the display has been diversified. For example, when an information device is a portable information device having mobility, a small light display showing low power consumption is necessary, and when an information device is an information transmission medium for the masses, a large display having a wide field angle is necessary.

In order to satisfy the aforementioned requirements, the display essentially requires a few conditions such as a large size, a low price, high performance, high accuracy, a small thickness and a small weight. Therefore, a thin light flat panel display which can replace a general cathode ray tube (CRT) must be developed to satisfy the above conditions.

Recently, as a device using field emission is applied to the display field, a thin film display which can reduce a size and power consumption and achieve high definition has been actively researched.

The field emission display is considered as a next generation flat panel display for information and communication which overcomes disadvantages of the developed or mass-produced flat panel displays, such as a liquid crystal display (LCD), a plasma display panel (PDP) and a vacuum fluorescent display (VFD). The field emission device is simple in electrode structure and operated at a high speed in the same principle as that of the CRT. In addition, the field emission device takes advantages of the display, such as unlimited colors, unlimited gray scales, high luminance and a high video processing speed.

The field emission display device emits visible rays according to quantum-mechanical tunneling which liberates electrons on a surface of a conductor from a vacuum when a high field is applied to the surface of the conductor in the vacuum. The field emission display device includes a bottom surface having an emitter which is an electron emission source, a top substrate having a fluorescent substance emitting light by collision of the electrons emitted from the emitter, and an anode electrode to which a high voltage is applied, a spacer disposed between the top substrate and the bottom substrate, for supporting the top substrate and the bottom substrate, and a sealing unit for maintaining vacuum and airtightness.

A carbon nano tube which is mechanically strong and chemically stable can emit electrons in a relatively low vacuum level. Recently, a field emission device using carbon nano tubes attains high importance. Since the carbon nano tube has a small diameter (about 1.0 to a few tens nm), it shows a higher field enhancement factor than a micro-tip of the general field emission device, thereby liberating the electrons in a low turn-on field (about 1 to 5V/μm). Accordingly, the field emission device using the carbon nano tubes can reduce power loss of the field emission display device, and cut down the unit cost of production.

A first example of a conventional field emission device and a fabrication method thereof will now be explained in detail with reference to FIG. 1.

FIG. 1 is a cross-sectional diagram illustrating the first example of the conventional field emission device.

Referring to FIG. 1, the conventional field emission device includes a silicon substrate 11, a resistive layer 12 formed on the silicon substrate 11, a catalyst transfer metal layer 13 formed at the center of the resistive layer 12, carbon nano tubes 16 formed on the catalyst transfer metal layer 13, insulation layers 14 symmetrically formed on the right and left sides of the resistive layer 12, and gate electrodes 15 formed on the insulation layers 14.

The conventional fabrication method of the field emission device includes the steps of sequentially forming a resistive layer 12, an insulation layer 14 and a gate electrode 15 on a silicon substrate 11, forming a hole by partially etching the gate electrode 15 and the insulation layer 14 according photolithography so that the resistive layer 12 can be exposed, forming a catalyst transfer metal layer 13 on the resistive layer 12 exposed through the hole according to evaporation deposition, and selectively forming carbon nano tubes 16 on the catalyst transfer metal layer 13 according to thermal chemical vapor deposition or plasma enhanced chemical vapor deposition using a hydrocarbon gas, by heating the whole silicon substrate 11 at a temperature of 600 to 900° C.

Here, the carbon nano tubes 16 are selectively formed merely on the catalyst transfer metal layer 13. As an area of the catalyst transfer metal layer 13 increases, an area of the carbon nano tubes 16 also increases. However, if the area of the carbon nano tubes 16 increases, the field formed by the gate electrodes 15 is not concentrated, and thus electron beams emitted from the carbon nano tubes 16 are dispersed. In the conventional field emission device, electron emission regions are not even, so that electrons may be locally emitted from the periphery of the hole having the highest field. In addition, a lot of current is leaked to the gate electrodes 15 due to asymmetrical field distribution.

In order to solve the above problems, there has been suggested a field emission device using carbon nano tubes in which a position of a gate electrode is equal to or lower than that of a cathode electrode. A second example of the conventional field emission device will now be explained.

FIG. 2 is a cross-sectional diagram illustrating the second example of the conventional field emission device.

As illustrated in FIG. 2, the conventional field emission device includes a bottom substrate 20, a gate electrode 21 formed on the bottom substrate 20, an insulation layer 22 formed on the gate electrode 21, a cathode electrode 23 formed at a part of the insulation layer 22, and carbon nano tubes 24 formed at a part of the cathode electrode 23.

The conventional fabrication method of the field emission device includes the steps of forming a gate electrode 21 on a bottom substrate 20, sequentially forming an insulation layer 22 and a conductive layer on the gate electrode 21, forming a cathode electrode 23 by patterning the conductive layer, and forming carbon nano tubes 24 by partially coating a carbon nano tube mixed slurry on the cathode electrode 23 according to screen printing, and performing a series of binder removing processes thereon.

The conventional field emission device is disadvantageous in that a value of a voltage applied to the gate electrode 21 and the cathode electrode 23 when electrons are emitted from the carbon nano tubes 24 (hereinafter, referred to as ‘turn-on voltage’) is relatively high because the gate electrode 21 is positioned below the cathode electrode 23. Moreover, abnormal light emission is caused by a high voltage applied to an anode electrode (not shown) formed later. In the abnormal light emission, even if a driving voltage is not applied to the gate electrode 21 and the cathode electrode 23 as high as the turn-on voltage, the electrons are emitted from the carbon nano tubes 24 by the high voltage applied to the anode electrode, so that the fluorescent substance can emit light.

So as to overcome the aforementioned disadvantages, there has been taught a field emission device using carbon nano tubes in which a gate electrode and a cathode electrode are formed on the same plane surface.

FIG. 3 is a cross-sectional diagram illustrating a third example of the conventional field emission device.

As depicted in FIG. 3, the conventional field emission device includes a bottom substrate 30, a bottom gate electrode 31 formed on the bottom substrate 30, an insulation layer 32 being formed on the bottom gate electrode 31, and having a via hole partially exposing the bottom gate electrode 31, a cathode electrode 33 formed on the insulation layer 32, a top gate electrode 34 formed on the same plane surface as that of the cathode electrode 33, and coupled to the bottom gate electrode 31 exposed through the via hole, and carbon nano tubes 35 formed on the cathode electrode 33. Here, the conventional fabrication method of the field emission device further includes exposure and etching processes in order to form the via hole for positioning the top gate electrode 34 and the cathode electrode 33 on the same plane surface. As a result, the conventional fabrication method of the field emission device is complicated.

In the conventional field emission device, the gate electrode 34 and the cathode electrode 33 are formed on the same plane surface, to lower a turn-on voltage. Therefore, a driving voltage of the field emission display device is advantageously reduced. However, when electrons emitted from the carbon nano tubes 35 are transferred to an anode electrode (not shown) to which a high voltage is applied, electron beams are seriously deflected, thereby causing crosstalk between the adjacent field emission display devices.

In the conventional field emission display device, the electrons are emitted to specific regions of the fluorescent substance-coated surface due to the deflected electron beams. That is, the conventional field emission display device shows low uniformity of screen which represents emission of visible rays on the whole fluorescent-coated surface when the electron beams are emitted to the whole fluorescent-coated surface. Especially, when an edge effect generated at one-side edges of the carbon nano tubes 35 is used, the electron beams emitted from the carbon nano tubes 35 are not transferred to the whole fluorescent substance-coated surface but to the specific regions. Accordingly, only the specific regions are excited by the electron beams, to deteriorate luminance of the field emission display device and uniformity of screen.

The conventional field emission display device forms the cathode electrode 33 as one electrode. As a result, a capacity of virtual condensers formed between the field emission display devices increases, which increases reactive power of the field emission display.

### SUMMARY OF THE INVENTION

Therefore, an object of the present invention is to provide a field emission display device which can improve luminance of a field emission display and uniformity of screen by enabling electrons to evenly excite the whole surface of a fluorescent substance, by forming a plurality of cathode electrodes and a plurality of gate electrodes to which a driving voltage is applied, and forming carbon nano tubes on the right and left sides of the plurality of cathode electrodes.

Another object of the present invention is to provide a field emission display device which can prevent crosstalk between the adjacent field emission display devices by reducing deflection of electrons emitted from a plurality of carbon nano tubes, by forming a plurality of cathode electrodes and a plurality of gate electrodes to which a driving voltage is applied, and forming the plurality of carbon nano tubes on the right and left sides of the plurality of cathode electrodes.

Yet another object of the present invention is to provide a field emission display device which can reduce reactive power, by forming a plurality of cathode electrodes and a plurality of gate electrodes to which a driving voltage is applied, and forming a plurality of carbon nano tubes on the right and left sides of the plurality of cathode electrodes.

To achieve these and other advantages and in accordance with the purpose of the present invention, as embodied and broadly described herein, there is provided a field emission display device, including: a bottom gate electrode formed on a bottom substrate; an insulation layer being formed on the bottom gate electrode, and having a via hole partially exposing the bottom gate electrode; a first top gate electrode formed on the insulation layer, and coupled to the bottom gate electrode exposed through the via hole; a first cathode electrode formed on the insulation layer on the same plane surface as that of the first top gate electrode; and a first carbon nano tube formed on the left side of the first cathode electrode, and a second carbon nano tube formed on the right side of the first cathode electrode.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross-sectional diagram illustrating a first example of a conventional field emission device;

FIG. 2 is a cross-sectional diagram illustrating a second example of the conventional field emission device;

FIG. 3 is a cross-sectional diagram illustrating a third example of the conventional field emission device;

FIG. 4 is a matrix structure diagram illustrating a field emission display to which field emission display devices are applied in accordance with a preferred embodiment of the present invention;

FIG. 5 is a cross-sectional diagram illustrating the field emission display device in accordance with the preferred embodiment of the present invention; and

FIG. 6 is a flowchart showing sequential steps of a fabrication method of a field emission display device in accordance with a preferred embodiment of the present invention.

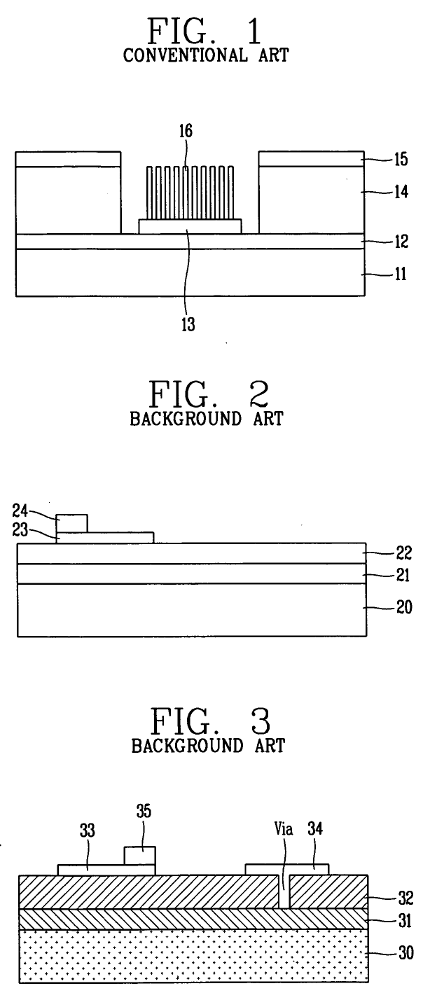

### DETAILED DESCRIPTION OF THE PREFERRED EMBODIMENTS

Reference will now be made in detail to the preferred embodiments of the present invention, examples of which are illustrated in the accompanying drawings.

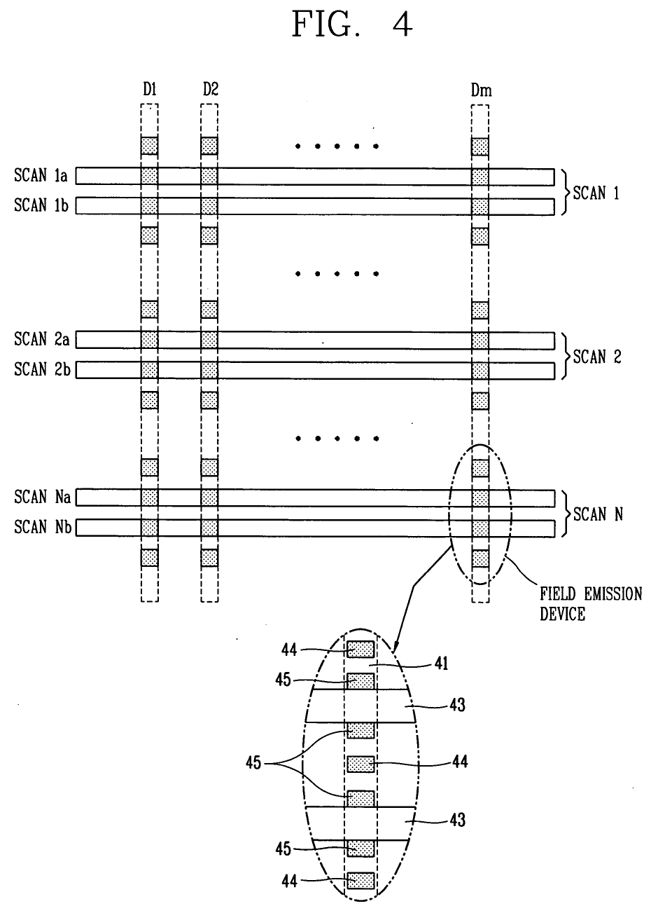

A field emission display device which can prevent crosstalk between the adjacent field emission display devices, improve luminance of a field emission display and uniformity of screen, and reduce a reactive power, by forming a plurality of cathode electrodes and a plurality of gate electrodes to which a driving voltage is applied, and forming a plurality of carbon nano tubes on the right and left sides of the plurality of cathode electrodes, and a fabrication method thereof in accordance with the preferred embodiments of the present invention will now be described in detail with reference to FIGS. 4 to 6.

FIG. 4 is a matrix structure diagram illustrating the field emission display to which the field emission display devices are applied in accordance with the present invention.

Referring to FIG. 4, the field emission display includes a plurality of gate lines D1 to Dm, and a plurality of cathode lines Scan 1 to Scan N orthogonal to the plurality of gate lines D1 to Dm. One field emission display device includes one gate line D1 and two cathode lines Scan 1a and Scan 1b.

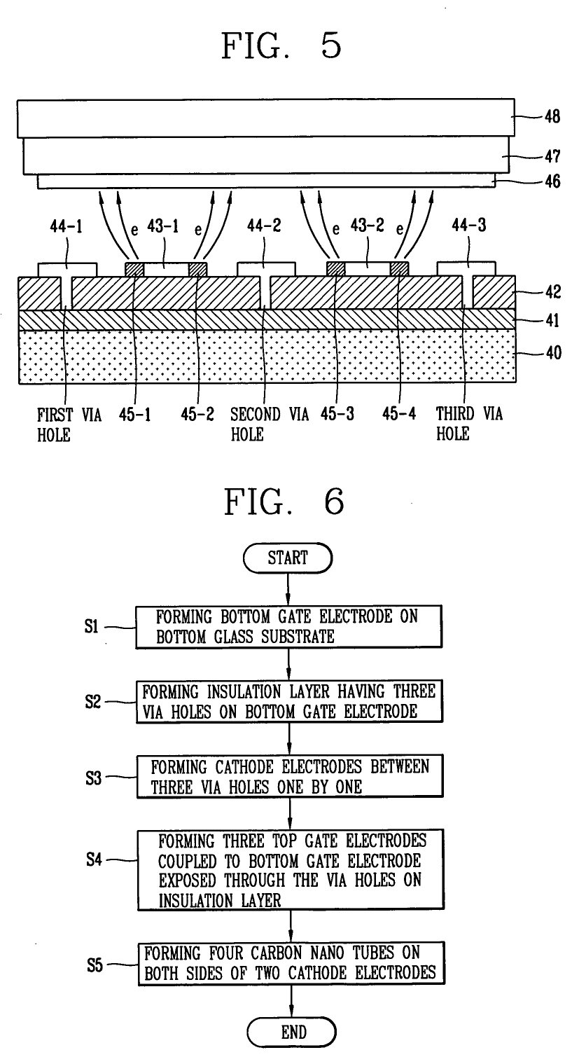

The structure of the field emission display device including the gate line D1 and the two cathode lines Scan 1a and Scan 1b will now be explained with reference to FIG. 5.

FIG. 5 is a cross-sectional diagram illustrating the field emission display device in accordance with the present invention.

As illustrated in FIG. 5, the field emission display device includes a bottom gate electrode 41 formed on a bottom glass substrate 40, an insulation layer 42 having a first via hole partially exposing the bottom gate electrode 41, a second via hole partially exposing the bottom gate electrode 41, and a third via hole partially exposing the bottom gate electrode 41, and being formed on the bottom gate electrode 41, a first cathode electrode 43-1 formed on the insulation layer 42 between the first via hole and the second via hole, a second cathode electrode 43-2 formed on the insulation layer 42 between the second via hole and the third via hole, a first top gate electrode 44-1 coupled to the bottom gate electrode 41 exposed through the first via hole, and formed on the same plane surface as that of the first cathode electrode 43-1, a second top gate electrode 44-2 coupled to the bottom gate electrode 41 exposed through the second via hole, and formed on the same plane surface as that of the first cathode electrode 43-1, a third top gate electrode 44-3 coupled to the bottom gate electrode 41 exposed through the third via hole, and formed on the same plane surface as that of the first cathode electrode 43-1, a first carbon nano tube 45-1 formed on the left side of the first cathode electrode 43-1, a second carbon nano tube 45-2 formed on the right side of the first cathode electrode 43-1, a third carbon nano tube 45-3 formed on the left side of the second cathode electrode 43-2, and a fourth carbon nano tube 45-4 formed on the right side of the second cathode electrode 43-2.

The operation of the field emission display device in accordance with the preferred embodiment of the present invention will now be described.

Still referring to FIG. 5, when a driving voltage is applied to the two cathode electrodes 43-1 and 43-2 and the bottom gate electrode 41, a field is generated between the three top gate electrodes 44-1, 44-2 and 44-3 coupled to the bottom gate electrode 41 and the two cathode electrodes 43-1 and 43-2. Electrons (e) are emitted from the four carbon nano tubes 45-1, 45-2, 45-3 and 45-4 formed at the both sides of the two cathode electrodes 43-1 and 43-2 by the field. The emitted electrons (e) are induced toward an anode electrode 47 formed on a top substrate by a high voltage applied to the anode electrode 47, thereby generating electron beams. Here, the induced electrons (e) collide against a fluorescent substance 46 formed on the top substrate. The fluorescent substance 46 having the electrons (e) excited by the collision emits visible rays. The field emission device reduces deflection of the electron beams emitted from the four carbon nano tubes 45-1, 45-2, 45-3 and 45-4, and improve luminance of the field emission display and uniformity of screen, by enabling the electrons emitted from the four carbon nano tubes 45-1, 45-2, 45-3 and 45-4 to collide against the whole area of the fluorescent substance 46.

Here, the field emission display device is not limited to the first via hole, the second via hole, the third via hole, the first cathode electrode, the second cathode electrode, the first top gate electrode, the second top gate electrode, the third top gate electrode, the first carbon nano tube, the second carbon nano tube, the third carbon nano tube, and the fourth carbon nano tube. For example, a number of the via holes, the cathode electrodes 43, the top gate electrodes 44 and the carbon nano tubes 45 can be changed.

A fabrication method of a field emission display device in accordance with a preferred embodiment of the present invention will now be described with reference to FIG. 6.

FIG. 6 is a flowchart showing sequential steps of the fabrication method of the field emission display device in accordance with the present invention.

As shown in FIG. 6, the fabrication method of the field emission display device includes the steps of forming a bottom gate electrode 41 on a bottom glass substrate 40 (S1), forming an insulation layer 42 having three via holes on the bottom gate electrode 41 (S2), forming cathode electrodes 43 on the insulation layer 42 between the three via holes one by one (S3), forming three top gate electrodes 44 coupled to the bottom gate electrode 41 (S4), and forming carbon nano tubes 45 on both sides of the two cathode electrodes 43 (S5).

The bottom gate electrode 41 is formed by coating a conductive layer on the bottom glass substrate 40 (S1). Here, the bottom gate electrode 41 serves as a common line for coupling the three bottom gate electrodes 44 formed later.

The insulation layer 42 is formed by coating an insulator on the bottom gate electrode 41, and etching the insulator coated on the bottom gate electrode 41 to form the first via hole 44-1, the second via hole 44-2 and the third via hole 44-3 partially exposing the bottom gate electrode 41 (S2). Preferably, the first via hole, the second via hole and the third via hole are formed on the insulation layer 42 at preset intervals.

The first cathode layer 43-1 is formed between the first via hole and the second via hole by patterning the conductive layer coated on the insulation layer 42. The second cathode layer 43-2 is formed between the second via hole and the third via hole by patterning the conductive layer coated on the insulation layer 42 (S3).

The first top gate electrode 44-1, the second top gate electrode 44-2 and the third top gate electrode 44-3 are formed by coating a conductive layer on the bottom gate electrode 41 exposed through the first via hole, the second via hole and the third via hole and the insulation layer 42, and patterning the coated conductive layer so that the first top gate electrode 44-1, the second top gate electrode 44-2 and the third top gate electrode 44-3 can be coupled to the bottom gate electrode 41 (S4). That is, the first top gate electrode 44-1 is coupled to the bottom gate electrode 41 through the first via hole, the second top gate electrode 44-2 is coupled to the bottom gate electrode 41 through the second via hole, and the third top gate electrode 44-3 is coupled to the bottom gate electrode 41 through the third via hole. Because the first top gate electrode 44-1, the second top gate electrode 44-2 and the third top gate electrode 44-3 are coupled to the bottom gate electrode 41 through the first via hole, the second via hole and the third via hole, the top gate electrodes are formed as many as the via holes. In addition, the bottom gate electrode 41 is coupled to the first top gate electrode 44-1, the second top gate electrode 44-2 and the third top gate electrode 44-3. The top gate electrodes 44-1, 44-2 and 44-3 are formed in a T shape.

The first carbon nano tube 45-1 is formed on the left side of the first cathode electrode 43-1 by coating a carbon nano tube mixed slurry according to screen printing, and performing a series of binder removing processes thereon. The second carbon nano tube 45-2 is formed on the right side of the first cathode electrode 43-1 by coating a carbon nano tube mixed slurry according to screen printing, and performing a series of binder removing processes thereon. The third carbon nano tube 45-3 is formed on the left side of the second cathode electrode 43-2 by coating a carbon nano tube mixed slurry according to screen printing, and performing a series of binder removing processes thereon. The fourth carbon nano tube 45-4 is formed on the right side of the second cathode electrode 43-2 by coating a carbon nano tube mixed slurry according to screen printing, and performing a series of binder removing processes thereon (S5).

Meanwhile, in the present invention, the first carbon nano tube 45-1 can be formed only on the left side of the first cathode electrode 43-1, the second carbon nano tube can be formed only on the right side of the cathode electrode 43-1, the third carbon nano tube 45-3 can be formed only on the left side of the second cathode electrode 43-2, and the fourth carbon nano tube 45-4 can be formed only on the right side of the second cathode electrode 43-2.

The first carbon nano tube 45-1 can be formed on a portion of the upper side of the first cathode electrode 43-1 by being extended from the left side of the first cathode electrode 43-1, the second carbon nano tube 45-2 can be formed on a portion of the upper side of the first cathode electrode 43-1 by being extended from the right side of the first cathode electrode 43-1, the third carbon nano tube 45-3 can be formed on a portion of the upper side of the second cathode electrode 43-2 by being extended from the left side of the second cathode electrode 43-2, and the fourth carbon nano tube 45-4 can be formed on a portion of the upper side of the second cathode electrode 43-2 by being extended from the right side of the second cathode electrode 43-2.

In addition, the first and second carbon nano tubes 45-1 and 45-2 can be formed only on a portion of the upper side of the first cathode electrode 43-1 and the third and fourth carbon nano tubes 45-3 and 45-5 can be formed only on a portion of the upper side of the second cathode electrode 43-2.

Here, the field emission display device is not limited to the first via hole, the second via hole, the third via hole, the first cathode electrode, the second cathode electrode, the first top gate electrode, the second top gate electrode, the third top gate electrode, the first carbon nano tube, the second carbon nano tube, the third carbon nano tube, and the fourth carbon nano tube. For example, a number of the via holes, the cathode electrodes 43, the top gate electrodes 44 and the carbon nano tubes 45 can be changed.

As discussed earlier, in accordance with the present invention, the field emission display device can prevent crosstalk between the adjacent field emission display devices by reducing deflection of the electron beams emitted from the plurality of carbon nano tubes, by forming the plurality of cathode electrodes and the plurality of gate electrodes to which the driving voltage is applied, and forming the plurality of carbon nano tubes on the right and left sides of the plurality of cathode electrodes.

In addition, the field emission display device using the carbon nano tubes can improve luminance of the field emission display and uniformity of screen by enabling the electrons emitted from the carbon nano tubes to evenly excite the whole surface of the fluorescent substance, by forming the plurality of cathode electrodes and the plurality of gate electrodes to which the driving voltage is applied, and forming the plurality of carbon nano tubes on the right and left sides of the plurality of cathode electrodes.

Furthermore, the field emission display device can reduce reactive power, by reducing the capacity of the virtual condensers formed between the field emission display devices by the plurality of cathode electrodes, by forming the plurality of cathode electrodes and the plurality of gate electrodes to which the driving voltage is applied, and forming the plurality of carbon nano tubes on the right and left sides of the plurality of cathode electrodes.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A field emission display device, comprising:
a bottom gate electrode formed on a bottom substrate;
an insulation layer being formed on the bottom gate electrode, and having a via hole partially exposing the bottom gate electrode;
a first top gate electrode formed on the insulation layer, and coupled to the bottom gate electrode exposed through the via hole;
a first cathode electrode formed on the insulation layer on the same plane surface as that of the first top gate electrode; and
a first carbon nano tube formed on the left side of the first cathode electrode, and a second carbon nano tube formed on the right side of the first cathode electrode.

2. The device of claim 1, further comprising a second cathode electrode formed on the same plane surface as that of the first top gate electrode.

3. The device of claim 2, further comprising a third carbon nano tube formed on the left side of the second cathode electrode, and a fourth carbon nano tube formed on the right side of the second cathode electrode.

4. The device of claim 3, wherein the first carbon nano tube is formed on the left side of the first cathode electrode, the second carbon nano tube is formed on the right side of the cathode electrode, the third carbon nano tube is formed on the left side of the second cathode electrode, and the fourth carbon nano tube is formed on the right side of the second cathode electrode.

5. The device of claim 3, wherein the first and second carbon nano tubes are formed only on a portion of the upper side of the first cathode electrode and the third and fourth carbon nano tubes are formed only on a portion of the upper side of the second cathode electrode.

6. The device of claim 3, wherein the first carbon nano tube is formed on a portion of the upper side of the first cathode electrode by being extended from the left side of the first cathode electrode, the second carbon nano tube is formed on a portion of the upper side of the first cathode electrode by being extended from the right side of the first cathode electrode, the third carbon nano tube is formed on a portion of the upper side of the second cathode electrode by being extended from the left side of the second cathode electrode, and the fourth carbon nano tube is formed on a portion of the upper side of the second cathode electrode by being extended from the right side of the second cathode electrode.

7. A field emission display device, comprising:
a bottom gate electrode formed on a bottom substrate;
an insulation layer being formed on the bottom gate electrode, and having a plurality of via holes partially exposing the bottom gate electrode;
a plurality of cathode electrodes formed on the insulation layer between the plurality of via holes;
a plurality of top gate electrodes coupled to the bottom gate electrode exposed through the plurality of via holes, and formed on the same plane surface as that of the plurality of cathode electrodes; and
carbon nano tubes formed on the right and left sides of the plurality of cathode electrodes.

8. The device of claim 7, wherein the plurality of cathode electrodes are formed between the top gate electrodes one by one.

9. The device of claim 7, wherein the number of the plurality of top gate electrodes is equal to or larger than three, the number of the plurality of cathode electrodes is equal to or larger than two, and the number of the carbon nano tubes is equal to or larger than four.

10. The device of claim 8, wherein the number of the plurality of top gate electrodes is equal to or larger than three, the number of the plurality of cathode electrodes is equal to or larger than two, and the number of the carbon nano tubes is equal to or larger than four.

11. A field emission display device, comprising:
a bottom gate electrode formed on a bottom substrate;
an insulation layer having a first via hole partially exposing the bottom gate electrode, a second via hole partially exposing the bottom gate electrode, and a third via hole partially exposing the bottom gate electrode, and being formed on the bottom gate electrode;
a first cathode electrode formed on the insulation layer between the first via hole and the second via hole;
a second cathode electrode formed on the insulation layer between the second via hole and the third via hole;
a first top gate electrode coupled to the bottom gate electrode exposed through the first via hole, and formed on the same plane surface as that of the first cathode electrode;
a second top gate electrode coupled to the bottom gate electrode exposed through the second via hole, and formed on the same plane surface as that of the first cathode electrode;
a third top gate electrode coupled to the bottom gate electrode exposed through the third via hole, and formed on the same plane surface as that of the first cathode electrode;
a first carbon nano tube formed on the left side of the first cathode electrode;
a second carbon nano tube formed on the right side of the first cathode electrode;
a third carbon nano tube formed on the left side of the second cathode electrode; and
a fourth carbon nano tube formed on the right side of the second cathode electrode.

12. A fabrication method of a field emission display device, comprising the steps of:
forming a bottom gate electrode on a bottom substrate;
forming, on the bottom gate electrode, an insulation layer having a via hole partially exposing the bottom gate electrode;
forming, on the insulation layer, a first top gate electrode coupled to the bottom gate electrode exposed through the through hole;
forming a first cathode electrode on the same plane surface as that of the first top gate electrode;
forming a first carbon nano tube on the left side of the first cathode electrode; and
forming a second carbon nano tube on the right side of the first cathode electrode.

13. The method of claim 12, further comprising a step for forming a second cathode electrode on the same plane surface as the first top gate electrode.

14. The method of claim 13, further comprising the steps of:
forming a third carbon nano tube on the left side of the second cathode electrode; and
forming a fourth carbon nano tube on the right side of the second cathode electrode.

15. The method of claim 14, wherein the first carbon nano tube is formed on the left side of the first cathode electrode, the second carbon nano tube is formed on the right side of the cathode electrode, the third carbon nano tube is formed on the left side of the second cathode electrode, and the fourth carbon nano tube is formed on the right side of the second cathode electrode.

16. The method of claim 14, wherein the first and second carbon nano tubes are formed only on a portion of the upper side of the first cathode electrode and the third and fourth carbon nano tubes are formed only on a portion of the upper side of the second cathode electrode.

17. The method of claim 14, wherein the first carbon nano tube is formed on a portion of the upper side of the first cathode electrode by being extended from the left side of the first cathode electrode, the second carbon nano tube is formed on a portion of the upper side of the first cathode electrode by being extended from the right side of the first cathode electrode, the third carbon nano tube is formed on a portion of the upper side of the second cathode electrode by being extended from the left side of the second cathode electrode, and the fourth carbon nano tube is formed on a portion of the upper side of the second cathode electrode by being extended from the right side of the second cathode electrode.

18. A fabrication method of a field emission display device, comprising the steps of:
forming a bottom gate electrode on a bottom substrate;
forming, on the bottom gate electrode, an insulation layer having a plurality of via holes partially exposing the bottom gate electrode;
forming a plurality of cathode electrodes on the insulation layer between the plurality of via holes;
forming, on the insulation layer, a plurality of top gate electrodes coupled to the bottom gate electrode exposed through the plurality of via holes; and
forming carbon nano tubes on the right and left sides of the plurality of cathode electrodes, respectively.

19. The method of claim 18, wherein the plurality of cathode electrodes are formed between the top gate electrodes one by one.

20. The method of claim 19, wherein the number of the plurality of top gate electrodes is equal to or larger than three, the number of the plurality of cathode electrodes is equal to or larger than two, and the number of the carbon nano tubes is equal to or larger than four.

21. The method of claim 19, wherein the carbon nano tubes are formed on the right and left sides of the plurality of cathode electrodes according to screen printing, respectively.

22. The method of claim 20, wherein the carbon nano tubes are formed on the right and left sides of the plurality of cathode electrodes according to screen printing, respectively.

23. A fabrication method of a field emission display device, comprising the steps of:
forming a bottom gate electrode on a bottom substrate;
forming, on the bottom gate electrode, an insulation layer having a first via hole, a second via hole and a third via hole that partially expose the bottom gate electrode;
forming a first cathode electrode on the insulation layer between the first via hole and the second via hole;
forming a second cathode electrode on the insulation layer between the second via hole and the third via hole;
forming, on the insulation layer, a first top gate electrode coupled to the bottom gate electrode exposed through the first via hole, and positioned on the same plane surface as that of the first cathode electrode;
forming, on the insulation layer, a second top gate electrode coupled to the bottom gate electrode exposed through the second via hole, and positioned on the same plane surface as that of the first cathode electrode;
forming, on the insulation layer, a third top gate electrode coupled to the bottom gate electrode exposed through the third via hole, and positioned on the same plane surface as that of the first cathode electrode;
forming a first carbon nano tube on the left side of the first cathode electrode;
forming a second carbon nano tube on the right side of the first cathode electrode;
forming a third carbon nano tube on the left side of the second cathode electrode; and
forming a fourth carbon nano tube on the right side of the second cathode electrode.
